(19) United States
(12) Patent Application Publication
(10) Pub. No.: US 2020/0261926 A1
(43) Pub. Date: Aug. 20, 2020

(54) Spray Head For An Agricultural Sprayer

(71) Applicant: Croplands Equipment Pty Ltd, Dry Creek (AU)

(72) Inventors: Leslie Roy Bollenhagen, Dry Creek (AU); Stephen Charles Norton, Stirling (AU); John Flint Packer, Evanston (AU)

(73) Assignee: Croplands Equipment Pty Ltd, Dry Creek (AU)

(21) Appl. No.: 16/790,570

(22) Filed: Feb. 13, 2020

(30) Foreign Application Priority Data
Feb. 14, 2019 (AU) 2019900471

(51) Int. Cl. B05B 1/26; A01M 7/00; B05B 1/34; A01C 23/04

(52) U.S. Cl. CPC B05B 1/26; A01M 7/0014; A01C 23/047; B05B 1/34; A01M 7/006

(57) ABSTRACT

A spray head for an agricultural sprayer, the spray head including a fan with a central axis, the spray head also including dual liquid manifolds coaxial about the fan's central axis, each manifold having a plurality of spray nozzles positioned to be capable of spraying liquid into air exiting the fan, and each manifold having a liquid inlet and a liquid outlet so as to permit individual control of liquid through each manifold.

This application claims priority from Australian provisional patent application 2019900471 filed Feb. 14, 2019, the full content of which is herein incorporated by reference.

### TECHNICAL FIELD OF THE INVENTION

The present invention relates to agricultural apparatus for spraying crops, particularly mobile sprayers designed to move along a line of crops for the purpose of spraying, for example, liquid insecticides, herbicides, fungicides and fertilisers onto those crops.

The present invention relates particularly to an improved spray head for such a mobile sprayer, being spray heads that utilise a fan for the production of a high-volume, turbulent, directional airstream into which a plurality of peripherally arranged nozzles can spray liquid.

### BACKGROUND OF THE INVENTION

In the absence of ideal growing conditions (adequate water supply, nutrients and a non-existence of pests), agriculturally or horticulturally grown crops require treatment of some type. Such treatments may include, for example, fungal treatment, watering, nutrient or fertiliser delivery, or the application of insecticides, pesticides or herbicides to the crops. These treatments often involve blowing an airstream or a liquid stream onto the crops where substances, usually in liquid form, are dispensed into the airstream or liquid stream to apply the substance to the crops in a spray.

In agriculture, plants may be grown in rows to enable treatments to be easily applied to the plants and/or to assist in the harvesting of the plants. Examples of such plants planted in rows include grape vines and fruit trees. The rows may be spaced apart so as to allow a vehicle or a tyre of a vehicle to travel between the rows.

To maximise the efficiency with which plants are treated with substances, mobile sprayers are often used to apply a substance to the plants. A range of sprayers are used, including sprayers that generate a spray by dispensing a substance into the airstream of a fan via a spray head that includes the fan and a plurality of spray nozzles. Mobile sprayers are able to be attached to, and moved along with, a vehicle. Particular mobile sprayers may utilise power from the vehicle to drive the fans of the spray heads, with the power from the vehicle being converted to drive the fans.

Many currently used spray heads do not provide much flexibility in operation with respect to liquid flowrates, or in relation to the ability to backwash or flush the spray nozzles and liquid lines. It is an aim of the present invention to provide an improved spray head for an agricultural sprayer.

Before turning to a summary of the solution provided by the present invention, it should be appreciated that reference to any prior art in this specification is not, and should not be taken as, an acknowledgment or any form of suggestion that this prior art forms part of the common general knowledge in any country. It should also be appreciated that the reference to “crop” throughout this specification is not intended to be a limitation of the type of plant, bush or tree that the apparatus of this invention might be used with.

### SUMMARY OF THE INVENTION

The present invention provides a spray head for an agricultural sprayer, the spray head including a fan with a central axis, the spray head also including dual liquid manifolds coaxial about the fan's central axis, each manifold having a plurality of spray nozzles positioned to be capable of spraying liquid into air exiting the fan, and each manifold having a liquid inlet and a liquid outlet so as to permit individual control of liquid through each manifold.

In a preferred form, the spray head includes a housing for mounting the fan and the manifolds thereto, the housing being annular such that the fan is mounted centrally within the housing, with the fan's trailing edges extending no further than the open front of the housing (where air exits the fan), and the fan's leading edges extending no further than the open rear of the housing (where air enters the fan).

In this respect, it will be appreciated that a reference to the “front” or “rear” of the fan, housing or spray head is a reference to the orientation of the fan, housing or spray head with reference to crops being sprayed, hence the crop-side is the front. However, a reference to the “entry” or “exit” of the fan, housing or spray head is a reference to the flow of air therethrough, meaning that the entry is at the rear and the exit is at the front.

In this preferred form, the manifolds will preferably be concentric rings mounted to the housing so as to be at the rear of the fan, ideally in the same radial plane as each other. The concentric rings may extend to form a full circle or may only extend to form a partial circle.

The manifolds are ideally positioned so as to be, in this form, close to the peripheral extent of the fan, either slightly outside or slightly inside that peripheral extent and thus near to the housing. Each of the plurality of spray nozzles of each manifold may then be located at the free end of a respective manifold riser extending away from a manifold and towards the front of the housing, each riser being long enough such that its spray nozzle is located at the front of the housing and is capable of spraying liquid into air exiting the fan.

Of course, it will be appreciated that the manifolds themselves may alternatively be positioned in front of the fan, or near the front of the fan, where there will likely be no need for the use of risers with the spray nozzles—spray nozzles may then be mounted directly on the manifolds.

As mentioned above, each manifold has its own liquid inlet and liquid outlet, a “liquid outlet” in this sense not being one of a manifold's spray nozzles, so as to provide a liquid pathway through a manifold from liquid inlet to liquid outlet, past the spray nozzles. With its liquid outlet open, liquid will thus exit a manifold via its outlet and its spray nozzles, whereas with its liquid outlet closed, liquid will exit a manifold only via its spray nozzles.

While the liquid outlet of one manifold of a spray head may be connected to the liquid inlet of the other manifold of that spray head, thus providing a single liquid pathway through the dual manifolds of that spray head, the improved flexibility of operation of the present invention is greatest when the manifolds are not connected in a single pathway, thus permitting individual control of liquid through each manifold of a spray head separately.

By way of illustration, and at least theoretically, this would permit a liquid of one type to be passed through and sprayed from one manifold of a spray head, with another liquid to be passed through and sprayed from the other manifold of that spray head. It is envisaged that such an option might be useful if a liquid herbicide passed through one manifold requires dilution for a period, wherein plain water might be passed through the other manifold at the same flowrate to halve (for example) the herbicide's strength when sprayed. Such an option might also be useful where, for example, there is a desire to allow visual markings to be applied to sprayed crops, where the first manifold delivers a herbicide and the other manifold delivers a colored dye.

Perhaps more usefully though is the ability to connect a manifold of one spray head to a manifold of another spray head to create a single liquid pathway through the two spray heads. Multiple spray heads may thus be connected together via the connection of manifolds, allowing for a system of spray heads to be connected in series or in parallel, or for a system of spray heads to have sections of spray heads where each section is connected in series or in parallel. With this in mind, it will be appreciated by a skilled addressee that the available options for possible combinations of manifold connections in systems of spray heads is large and, without excluding any of those possible combinations from the available scope of this invention, it will also be appreciated that not all of those possible combinations will be described here.

Returning now to a description of a single spray head, the individual control of liquid through each spray head manifold permits the use of different flowrates through each, such that, for example, one flowrate can be delivered by having a single manifold operating, another higher flowrate could be delivered by having only the other manifold operating (at a higher set flowrate), with a third flowrate being deliverable when both manifolds are operated together, providing an individual spray head with three tiers of operation.

Of course, this latter benefit might also be provided simply by utilizing different spray nozzles on each manifold, thus delivering the different flowrates mentioned above when applying a single flowrate through the manifolds, by relying on nozzles with different flowrates and/or spray patterns.

Individual control of the manifolds may be provided by pumps and manually operable valves, or by pumps and servo valves controlled via one or more electronic rate controllers. Control may be manually or electronically split into sections, such as sections of spray heads that might be referred to as a “left-side” (or a “left-hand”) section of spray heads, or a right-side section of spray heads, or “first” manifolds or “second” manifolds (being “sections” determined by liquid pathways through connected manifolds), or upper or lower sections of spray heads on a sprayer. Where electronically controlled, there may be two controllers, one for each manifold on a spray head, perhaps with one providing a specific or special function.

It will be appreciated that another benefit of the flexibility provided by the spray head of the present invention is the ease in which a spray head, or a section of spray heads in a spray head system, may be primed before use, or may be drained or flushed after use. For example, conventional spray head manifolds provide closed systems, meaning that liquid can only leave the system via the spray nozzles. However, spray sediments can build up in a manifold and it tends to be difficult to flush out larger contaminants. This is particularly a problem where powder-based chemical solutions are used, such as with horticultural spraying systems.

In the present invention, one or both of the manifolds of a spray head can be configured to always provide some liquid flow back to a main tank (such as from the last spray head in a series of spray heads) so that there is always recirculating liquid movement through the manifolds in such a system.

Alternatively, and perhaps more likely, one or both of the manifolds of a spray head can be configured such that the system may be left closed until spraying is finished, at which time a drain valve at the end of a series of spray heads may be operated (either manually or electronically) to permit continued operation to flush the lines with, for example, fresh water, and the draining of the manifolds either to the ground or to a purpose-built disposal pit (if available).

Further still, individual lines may be provided from each manifold in each spray head, each with separately operable drain valves to permit the flushing of its line, such that each manifold can be drained separately of each other manifold. This arrangement can significantly reduce the flushing and draining time of a spray head.

In yet another form of the present invention, a spray head may include additional manifolds (ie, more than two manifolds). Where the spray head does include an additional manifold (such as a third manifold), each additional manifold will also preferably have a plurality of spray nozzles positioned to be capable of spraying liquid into air exiting the fan, and each additional manifold will also preferably have a liquid inlet and a liquid outlet so as to permit individual control of liquid through each additional manifold.

In this form, each additional manifold will preferably be of the same general configuration as the first two manifolds, and thus all manifolds will preferably be concentric rings mounted to the housing so as to be at the rear of the fan, ideally in the same radial plane as each other, as outlined above.

In summary, it will be appreciated that the spray head of the present invention provides improved flexibility in operation, particularly in terms of spray options. The spray head provides the option of at least three tiers of operation, being operation through a first manifold only, through a second manifold only, or through the two manifolds together. Such a three-tier system does not only allow selective variation of spray volumes, but also permits the optimisation of the types of spray nozzles used in order to provide for a desired coverage or spray efficacy.

Also, the spray head of the present invention provides the ability to flush and drain lines easily, and readily permits a variety of plumbing connections, so that multiple spray heads can be used in series or in parallel, with their manifolds joined or separated, with each spray head configured for one, two or three tiers of operation, or used for direct chemical injection (a raw chemical flowing directly to spray lines, not via a main tank) if desired.

### BRIEF DESCRIPTION OF THE DRAWINGS

A preferred embodiment of a spray head, and several preferred embodiments of spray head systems, in accordance with the present invention will now be described in relation to the accompanying drawings. However, it must be appreciated that the following description is not to limit the generality of the above description.

In the drawings:

FIGS. 1a and 1b are perspective views from the front of a spray head in accordance with a preferred embodiment of the present invention, with FIG. 1a being the spray head without a housing (for ease of illustration) and FIG. 1b showing the spray head of FIG. 1a with a housing;

FIGS. 2a and 2b are perspective views from the rear of the spray head of FIGS. 1a and 1b, with FIG. 2a again being the spray head without a housing and FIG. 2b showing the spray head of FIG. 2a with a housing;

FIG. 3 is a perspective schematic view from the front of just the dual manifolds of the of spray head of FIGS. 1a and 1b;

FIG. 4 is a schematic drawing of a system for connecting multiple of the spray heads of the present invention; and

FIGS. 5a and 5b are schematic drawings of two further systems for connecting multiple of the spray heads of the present invention.

### DETAILED DESCRIPTION OF PREFERRED EMBODIMENT

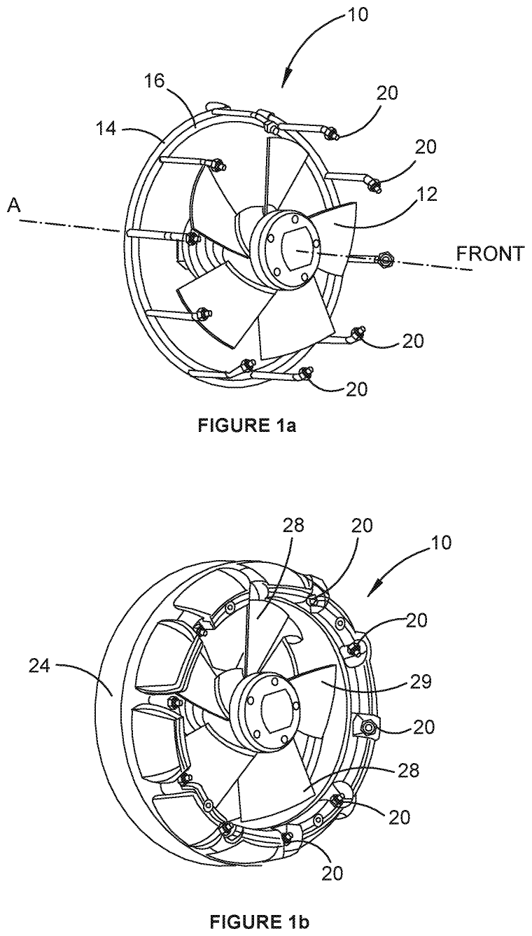

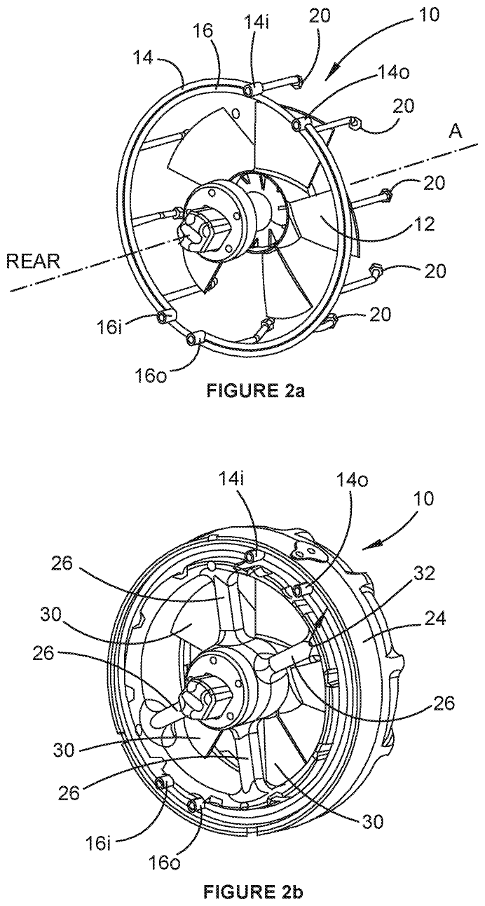

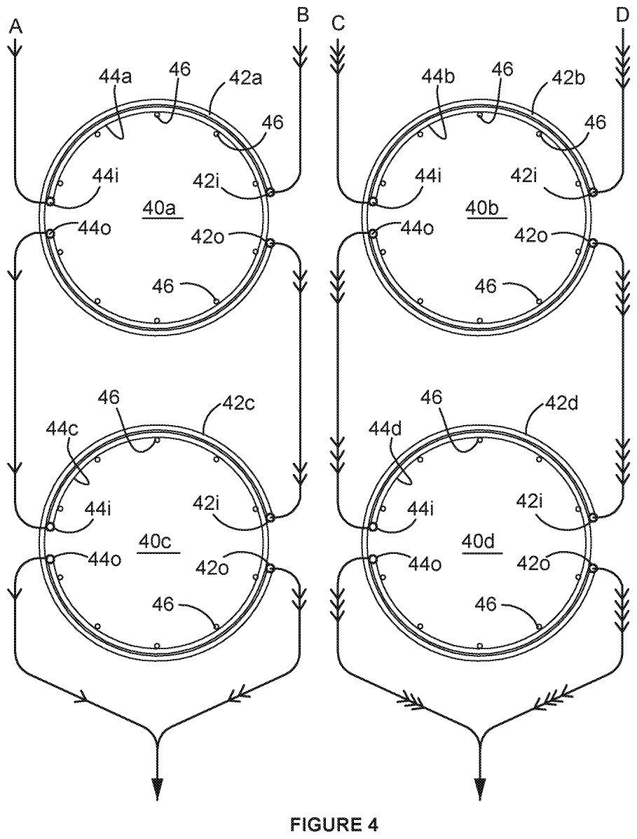

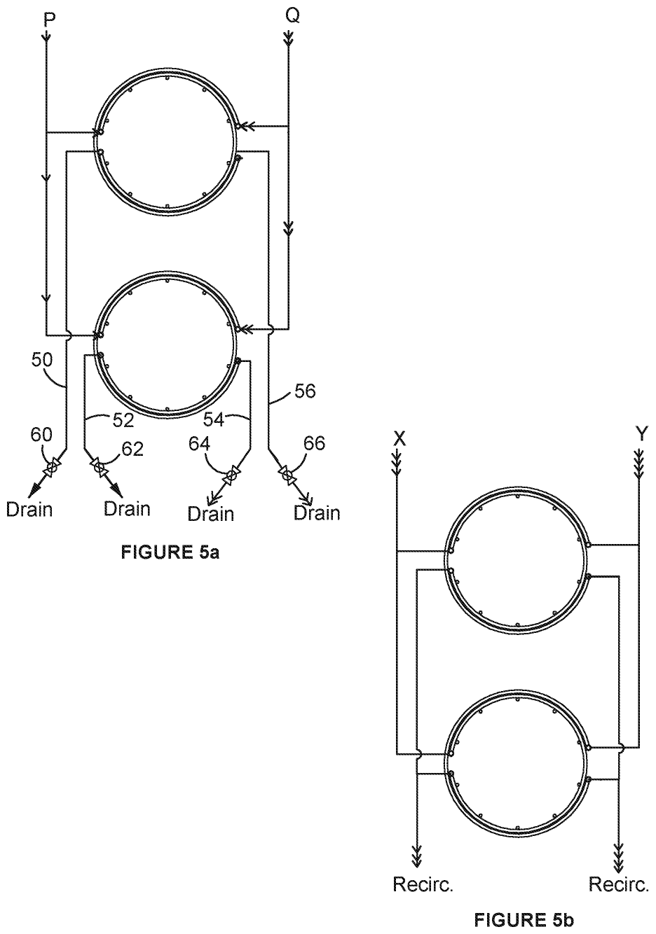

Illustrated in FIGS. 1a and 2a are front and rear views respectively of a spray head 10 in accordance with a preferred embodiment of the present invention. The spray head 10 includes a fan 12 with a central axis A and dual liquid manifolds 14, 16 coaxial about the central axis A of the fan 12. Each manifold 14, 16 has a plurality of spray nozzles 20 positioned to be capable of spraying liquid into air exiting the fan 12 at the front thereof, and each manifold 14, 16 also has a liquid inlet 14i, 16i and a liquid outlet 14o, 16o (see FIG. 2a) so as to permit individual control of liquid through each manifold 14, 16 as generally described above and as will be described below in relation to the systems of FIGS. 4, 5a and 5b.

As is illustrated in FIGS. 1b and 2b, again being views from the front and the rear respectively, the spray head 10 includes a housing 24 (in the form of a cowling) for mounting the fan 12 and the manifolds 14, 16 thereto, the housing 24 being annular such that the fan 12 is mounted centrally within the housing 24 via mounting arms 26 (see FIG. 2b), with the trailing edges 28 of the fan 12 extending no further than the open front of the housing 24 (where air exits the fan 12), and the leading edges 30 of the fan 12 extending no further than the open rear of the housing 24 (where air enters the fan 12).

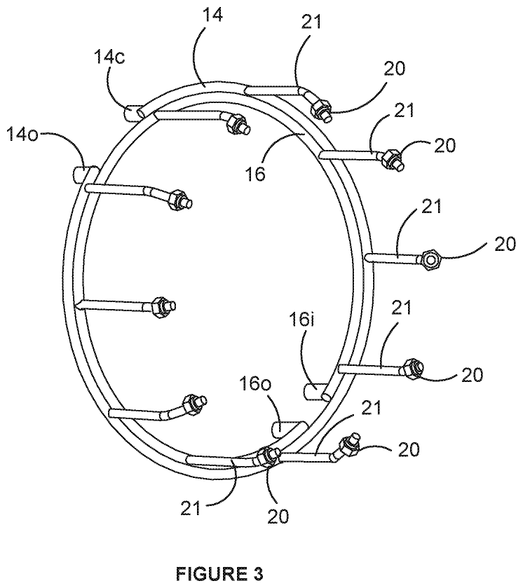

As can be more clearly be seen in FIG. 3, in this embodiment the manifolds 14, 16 are concentric rings mounted to a correspondingly shaped channel 32 at the rear of the housing 24 so as to be at the rear of the fan 12, in the same radial plane as each other. The concentric rings may extend to form a full circle or may only extend to form a partial circle as can be seen in FIG. 3 where the respective manifolds inlet and outlet (14i, 14o and 16i, 16o) are located close to each other but not directly adjacent to each other. Having said that, it will be appreciated that the manifolds need not be mounted in the same radial plan as each other, but may be mounted one in front of the other.

In this embodiment, it can be seen that the manifolds 14, 16 are positioned so as to be close to the peripheral extent of the fan, and slightly outside that peripheral extent. Each of the plurality of spray nozzles 20 of each manifold 14, 16 is then located at the free end of a respective riser 21 (see FIG. 3) extending from a manifold 14, 16 towards the front of the housing 24. Each riser 21 is long enough such that its respective spray nozzle 20 is located at the front of the housing 24 and is capable of spraying liquid into air exiting the fan 12. Of course, the use of such risers 21 is not essential, nor is the positioning of the manifolds 14, 16 towards the rear of the housing 24. The manifolds 14, 16 may alternatively be mounted towards the front of the housing 24, or the middle of the housing 24, with spray nozzles 20 mounted directly on the manifolds 14, 16 without the need for risers 21.

Finally, it will be appreciated that with the embodiment illustrated in FIGS. 1 to 3, individual control of the manifolds 14, 16 may be provided by suitable pumps and either by manually controlled valves or by servo valves (not shown), the servo valves being controlled via one or more electronic rate controllers (also not shown), with liquid lines connected to the inlets/outlets (14i, 14o and 16i, 16o) and attached to a main supply tank or a drainage outlet as desired and as will be described below in relation to some possible spray head systems.

In relation to the use of spray systems that utilise multiple spray heads of the above described type, a benefit of the spray heads of the present invention is the ability to connect a manifold of one spray head to a manifold of another spray head to create a single liquid pathway through the two spray heads. Multiple spray heads may thus be connected together via the connection of manifolds, allowing for a system of spray heads to be connected in series or in parallel, or for a system of spray heads to have sections of spray heads where each section is connected in series or in parallel.

FIG. 4 illustrates one such system, where four spray heads (40a to 40d) have been adopted, notionally in two sections, being a left-hand section (40a, 40c) and a right-hand section (40b, 40d). Each spray head (40a to 40d) is illustrated schematically from its rear in FIG. 4, and simply as having an outer manifold (42a to 42d) and an inner manifold (44a to 44d), each having respective liquid inlets (42i, 44i) and liquid outlets (42o, 44o) and a number of spray nozzles 46 therearound.

This system is able to be interconnected such that liquid path A is from a source tank (not shown) through liquid inlet 44i of inner manifold 44a of spray head 40a, through inner manifold 44a, out of liquid outlet 44o, into liquid inlet 44i of inner manifold 44a of spray head 40c, through inner manifold 44a and out of liquid outlet 44o. Liquid path A may be individually controlled using appropriate upstream valves and controllers (not shown) and may return to the source tank. As can be seen from FIG. 4, four such pathways A, B, C and D may be provided in this dual section system, allowing for a wide degree of variation in fluid flows through spray heads as desired.

FIGS. 5a and 5b illustrate two further spray head systems, this time only including two spray heads in each, which for clarity have had the reference numerals removed, such that the following description will only be of the liquid paths P and Q (FIG. 5a) and X and Y (FIG. 5b) of the two systems.

The dual spray head system of FIG. 5a includes two incoming liquid pathways P and Q that supply liquid (either the same liquid or a different liquid) from a source tank (not shown) to the inner manifolds (path P) and the outer manifolds (path Q) of the two spray heads via a single line servicing the spray heads consecutively. Liquid not exiting through the spray nozzles then exits the spray heads via four separate lines (50, 52, 54, 56), each equipped with its own valves (60, 62, 64, 66) to allow, when needed, draining of each of the four manifolds (either consecutively or concurrently, as desired), with or without the flushing of the manifolds.

In an alternative arrangement, the dual spray head system of FIG. 5b includes two incoming liquid pathways X and Y that supply liquid (again, either the same liquid or a different liquid) to the inner manifolds (path X) and the outer manifolds (path Y) of the two spray heads, again via a single line servicing the spray heads consecutively. Liquid not exiting through the spray nozzles then exits the spray heads via a single line servicing the spray heads consecutively, to be recirculated back to the main tank. Again, some degree of control (valves, etc) can be provided in these lines returning to the source tank for the purposes of flushing, or simply for controlling recirculation.

Embodiments such as those illustrated in FIGS. 5a and 5b (particularly) and FIG. 4 have been found to avoid undesirably high pumping pressures while still providing for the passage of required volumes of liquid and for desirable spray outcomes, and at the same time permit flexibility of spray and liquid variation for the user, with relatively simple priming, flushing, drainage, recirculation and maintenance options.

Those skilled in the art will appreciate that the invention described herein is susceptible to variations and modifications other than those specifically described. It is to be understood that the invention includes all such variations and modifications.

1. A spray head for an agricultural sprayer, the spray head including a fan with a central axis, the spray head also including dual liquid manifolds coaxial about the fan's central axis, each manifold having a plurality of spray nozzles positioned to be capable of spraying liquid into air exiting the fan, and each manifold having a liquid inlet and a liquid outlet so as to permit individual control of liquid through each manifold.

2. A spray head according to claim 1, wherein the manifolds are in the same radial plane.

3. A spray head according to claim 1, wherein the manifolds are behind the fan.

4. A spray head according to claim 1, wherein the manifolds are in front of the fan.

5. A spray head according to claim 1, wherein the manifolds are at or near the periphery of the fan.

6. A spray head according to claim 1, wherein the manifolds are within the periphery of the fan.

7. A spray head according to claim 1, including a housing for mounting the fan and the manifolds thereto.

8. A spray head according to claim 1, wherein individual control of the manifolds is provided for each one manifold separate to the other.

9. A spray head according to claim 1, wherein the spray nozzles of one manifold are of a different flowrate and/or spray pattern as the other manifold.

10. A spray head according to claim 1, wherein the manifolds are annular.

11. A spray head according to claim 1, wherein the manifolds are part-annular.

12. A spray head according to claim 1, wherein the spray head includes one or more additional manifolds.

13. A spray head according to claim 1, wherein the spray head includes one or more additional manifolds, each additional manifold also having a plurality of spray nozzles positioned to be capable of spraying liquid into air exiting the fan, and each additional manifold also having a liquid inlet and a liquid outlet so as to permit individual control of liquid through each manifold separate to each other manifold.

14. A system of spray heads, the system including at least two of the spray heads of claim 1, each spray head in fluid communication with each other spray head, the system including two incoming liquid pathways that supply liquid to inner manifolds and outer manifolds of the spray heads via a single line servicing the spray heads consecutively.

15. A system according to claim 14, wherein liquid not exiting through spray nozzles then exits the spray heads via separate lines, each equipped with its own valves to allow draining of each of the manifolds either consecutively or concurrently.

16. A system according to claim 14, wherein liquid not exiting through spray nozzles then exits the spray heads via a single line servicing the spray heads consecutively, to be recirculated back to a source tank.
